(19) United States
(12) Patent Application Publication
(10) Pub. No.: US 2026/0203759 A1
(43) Pub. Date: Jul. 16, 2026

(54) FRAUD DETECTION USING GENERATIVE ARTIFICIAL INTELLIGENCE FOR CONTINUOUS INFORMATION VALIDATION

(71) Applicant: Wells Fargo Bank, N.A., San Francisco, CA (US)

(72) Inventors: Niladri Bhattacharya, Livingston, NJ (US); Frank H. Dix, New York, NY (US); Michael Charles Reynolds, Avon, CT (US)

(21) Appl. No.: 19/020,946

(22) Filed: Jan. 14, 2025

(51) Int. Cl. G06Q 20/40; G06N 3/0475

(52) U.S. Cl. CPC G06Q 20/4016; G06N 3/0475

(57) ABSTRACT

A method may include receiving, using a processing unit, a trigger event notification associated with verification of an identity of a user account; in response to the receiving, automatically generating an input data structure formatted in accordance with an input format of a generative artificial intelligence machine learning model (genAI model); executing the genAI model using the input data structure; in response to the executing, processing an output of the genAI model, the output including identity verification data for the user account; executing a risk machine learning model with the identity verification data; updating a risk factor value for the user account based on an output of the risk machine learning model; and executing a risk mitigation action for the user account based on the updated risk factor value.

### BACKGROUND

In financial industries, regulations often require identity verification to prevent identity theft, financial fraud, money laundering, and terrorist financing. Programs are implemented to perform checks at an onboarding stage and periodically depending on the customer's risk level. Some of these processes involve collecting and verifying customer information, such as legal names, addresses, identification documents, and financial data.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Like numerals having different letter suffixes may represent different instances of similar components. Some embodiments are illustrated by way of example, and not limitation, in the figures of the accompanying drawing.

FIG. 1 is a block diagram of the components of a client device and an application server, according to various examples.

FIG. 2 is a diagram illustrating pipelines for training and using a machine learning model, according to various examples.

FIG. 3 is a block diagram illustrating using a genAI model to generate identity verification data, according to various examples.

FIG. 4 is a user interface for reviewing the output of a genAI model, according to various examples.

FIG. 5 is a block diagram of operations of a method, according to various examples.

FIG. 6 is a block diagram illustrating a machine in the example form of a computer system within which a set or sequence of instructions may be executed to cause the machine to perform any one of the methodologies discussed herein, according to various examples.

### DETAILED DESCRIPTION

Certain companies are bound by regulatory requirements to verify the identity of their customers. For example, when a user (e.g., an individual or business entity) opens an account at a financial institution, the documentation provided by the user should be processed to ensure the information is accurate and cross-checked to ensure the names and transactions associated with the account are not on any watchlists. This verification process is commonly referred to as Know Your Customer (KYC).

Consider the KYC process for a user (e.g., a small business owner) who seeks to open an account at a bank or other. The KYC process may begin with collecting information from the small business owner, such as basic details such as the full name, address, date of birth (if applicable), and identification documents like a government-issued ID or passport. For businesses, additional information may be required to verify the entity itself, including articles of incorporation, registration certificates, tax IDs, and any other official documentation that proves the business's legal existence.

The bank may verify this information against reliable databases and public records. This step may include checking the authenticity of the provided documents using verification tools or online services. For small businesses, the legitimacy of the entity and the identities of key individuals such as owners, directors, or authorized signatories are checked.

The financial institution may also perform a risk assessment based on the collected information and any additional factors that might influence the business's profile. This step may include evaluating the nature of the business operations, financial activities, geographic location, and industry sector to determine potential risks associated with money laundering, terrorism financing, or other illicit activities. The risk assessment may be performed using a machine learning model, as shown in various examples.

Several problems may arise when manually performing the KYC process. These may include human errors such as misinterpretation of documents or incorrect data entry, which can compromise the integrity of the KYC process. Additionally, inconsistencies in the application of standards among different employees can result in some accounts being improperly approved while others are unfairly denied access based on erroneous assessments. Furthermore, regulatory compliance risks increase due to potential non-compliance with legal requirements. Fraud vulnerability is another concern, as manual verification may be more susceptible to identity theft or account takeover. Also, handling sensitive customer data manually exposes it to security risks such as breaches, loss, or misuse by unauthorized personnel. These challenges highlight the deficiencies in KYC's existing manual processes.

Additionally, while companies provide training and job aids to assist KYC analysts, these support mechanisms often fail to keep pace with the evolving knowledge and skills required to detect emerging fraud schemes, such as attempts to create fraudulent company entities to obscure the true identity of the onboarding entity. Another challenge arises from the financial institutions'efforts to expedite the onboarding of new customers. The pressure to accelerate this process may limit their capacity to conduct thorough investigative due diligence.

Finally, one of the most significant challenges in KYC fraud detection is the occurrence of false positives. A substantial portion of onboarding requests are routinely delayed for weeks or even months due to the need for enhanced due diligence resulting from ‘red flags’ during the typical KYC assessments, which indicate that the onboarding entity may require further investigation before approval. Unfortunately, many of these indications are false positives that could have been avoided with more accurate detection algorithms or improved analysis of the submitted documentation.

Additionally, regular classification-style machine-learning models are insufficient to address many of the problems found in manual KYC performance. KYC processes involve multifaceted decisions that require understanding a wide range of contextual information, including legal requirements, risk assessment criteria, and customer behavior patterns. Standard classification models are often too simplistic to capture the nuanced decision-making required in such complex scenarios. Financial regulations and fraud detection requirements can evolve rapidly. Traditional machine learning models typically need retraining with updated data to adapt, which may not be feasible or timely enough for dynamic environments like banking operations where real-time adjustments are crucial. Furthermore, regulatory standards may require transparency in decision-making processes. Standard classification models cannot often explain their decisions clearly, making it challenging to justify approvals or rejections during an audit or dispute resolution process.

Another challenge is that KYC involves a series of sequential steps where the output from one step feeds into another (e.g., document verification followed by identity matching). Traditional classification models often operate in isolation, making it challenging to design end-to-end solutions that seamlessly integrate these multi-step processes.

Given the problems with existing KYC processes, described herein are systems and methods using generative artificial intelligence (genAI) to assist in KYC processes. GenAI models often use a transformer model that is particularly adept at handling complex contextual tasks such as those involved in KYC processes. For example, the transformer model uses self-attention to weigh the importance of different elements within a sequence, allowing it to focus on relevant parts of the input data. For example, in identity verification, self-attention leads to understanding how different pieces of information (e.g., name, address, date of birth) relate. Transformers also incorporate positional encoding to understand the order and context within sequences. The transformer architecture may be fine-tuned on new data without significant retraining from scratch. This flexibility allows the model to adapt quickly to emerging trends and changes, such as new types of identities or fraud methods.

Another benefit of the transformers is they are versatile enough to handle different data modalities (text, images, video) by being trained on multiple types of inputs simultaneously or sequentially. This capability is helpful in KYC processes involving various identity verification forms. Furthermore, transformers may learn hierarchical representations of the input data (e.g., documents provided by a user), capturing complex relationships and dependencies between different features.

The described systems and methods leverage generative AI and machine learning models to automate and enhance KYC processes for user account verification. A method may begin by receiving a trigger event notification, which could be associated with new documentation submissions or periodic reviews. In response to this trigger, a system automatically generates an input data structure formatted according to a genAI model's requirements. For example, generating may include selecting an appropriate input prompt and adding relevant data files to the genAI model's context window.

The genAI model then processes this structured input, producing identity verification data for the user account, which may include validated identification documents and corroborated personal information. The system may execute a risk assessment machine learning model using the generated identity verification data. Based on the output from this risk assessment model, the system may update the risk factor value for the user account, reflecting any changes in its risk profile.

Finally, the updated risk factor value may trigger specific risk mitigation actions. These actions may include additional verification steps, account restrictions, or enhanced monitoring procedures. By integrating generative AI with machine learning models, the systems and methods ensure continuous and dynamic KYC compliance while enhancing the accuracy and efficiency of identity verification and risk assessment processes.

The following description outlines specific examples to provide a thorough understanding of various inventive aspects. It will be evident, however, to one skilled in the art that the present invention may be practiced without these specific details. References in the specification to “one example,” “an example,” “an illustrative example,” etc., indicate that the example described may include a particular feature, structure, etc. Still, every example may not necessarily include that particular feature. Additionally, such phrases do not imply a single example, and the features may be incorporated into other examples described. It may be appreciated that lists in the form of “at least one A, B, and C” may mean (A); (B); (C): (A and B); (B and C); or (A, B, and C). Similarly, items listed in the form of “at least one of A, B, or C” can mean (A); (B); (C): (A and B); (B and C); or (A, B, and C). Furthermore, using such phrases does not negate the possibility of other options (e.g., (D)).

Throughout this disclosure, components may perform electronic actions in response to different variable values (e.g., thresholds, user preferences, etc.). As a matter of convenience, this disclosure does not always detail where the variables are stored or how they are retrieved. In such instances, it may be assumed that the variables are stored on a storage device (e.g., Random Access Memory (RAM), cache, hard drive) accessible by the component via an Application Programming Interface (API) or other program communication method. Similarly, the variables may be assumed to have default values should a specific value not be described. End-users or administrators may use user interfaces to edit the variable values.

In various examples described herein, user interfaces are described as being presented to a computing device. The presentation may include data transmitted (e.g., a hypertext markup language file) from a first device (such as a web server) to the computing device for rendering on a display device of the computing device via a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples, these portions may be displayed on a screen simultaneously, in others, the portions/elements may be displayed on separate screens such that not all portions/elements are displayed simultaneously. Unless explicitly indicated as such, the use of “presenting a user interface” does not infer either one of these options.

Additionally, the elements and portions are sometimes described as being configured for a particular purpose. For example, an input element may be configured to receive an input string, a selection from a menu, a checkbox, etc. In this context, “configured to” may mean presenting a user interface element capable of receiving user input. “Configured to” may additionally mean computer executable code processes interactions with the element/portion based on an event handler. Thus, a “search” button element may be configured to pass text received in the input element to a search routine that formats and executes a structured query language (SQL) query to a database.

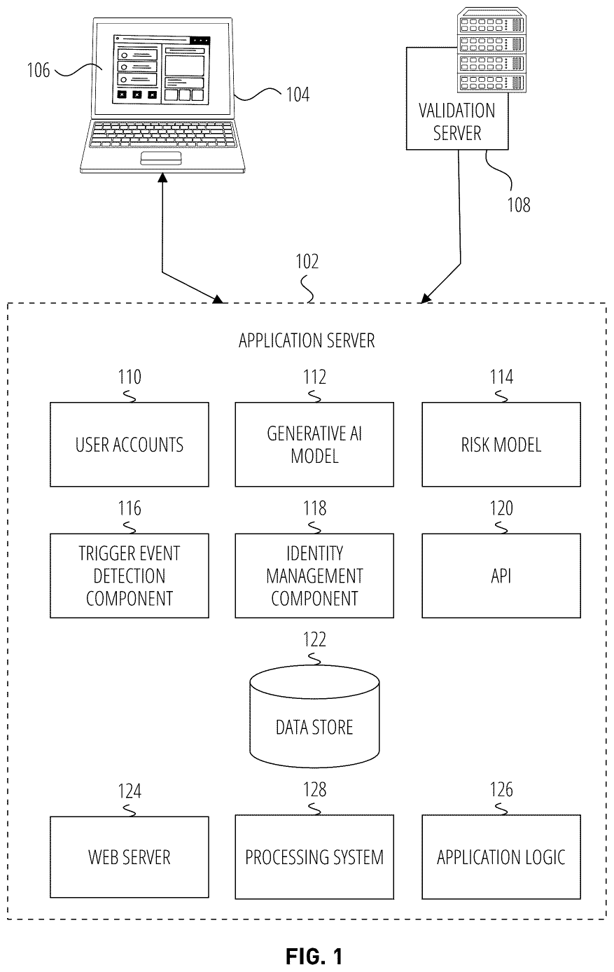

FIG. 1 is a block diagram of the components of a client device and an application server, according to various examples.

User accounts 110 may store user profiles for users of application server 102. When a user creates an account at a financial institution, an account is created within user accounts 110. The account may store user-provided documentation to verify the user's identity and ensure compliance with regulatory requirements. The types of documents stored in user accounts 110 may include identification documents, such as government-issued IDs like passports, driver's licenses, or national identity cards, which are used to verify the user's identity. Address verification documents, such as utility bills, bank statements, or rental agreements, may be used to confirm the user's residential address. Income source documents, such as pay stubs, tax returns, or bank statements showing regular deposits, may further help to verify the user's financial stability and risk profile. For business accounts, corporate structure documents, such as articles of incorporation, registration certificates, business licenses, permits, tax forms, and other entity organization forms are stored to verify the legitimacy of the business entity and its key individuals, such as owners, directors, or authorized signatories. Additional documents for commercial or corporate clients may include merger and acquisition records, lease agreements, stock certificates, and international variations of the aforementioned documents.

The documents may be stored using a standardized format that includes an identifier (e.g., Universally Unique Identifier, UUID), a title, etc. In such a manner, a user account may be associated with a document in a database schema by listing the document's identifier and an identifier of the user account.

The user profile within user accounts 110 may also include credential information such as a username and a password hash. When a user enters their username and plaintext password on a login page of application server 102, the system verifies the credentials to grant access to the user profile information or interfaces presented by application server 102.

The identity management component 118 may facilitate the verification of user-provided documents and ensure compliance with regulatory requirements. This component may exist in a variety of forms. For example, the identity management component 118 may be a standalone application that compliance users, such as those performing the Know Your Customer (KYC) process, use to manually verify the documents provided by users. In this form, compliance users can interact with the application to review, validate, and approve the documentation submitted by users during the account creation process.

In another form, the identity management component 118 may be implemented as a plug-in to a web browser, providing compliance users with a seamless and integrated tool for document verification within their existing workflow. This plug-in can enhance the efficiency of the KYC process by allowing users to access and verify documents directly from their browser without switching between different applications or interfaces.

In another form, the identity management component 118 may function as an automated backend process without direct user intervention. The component may automatically process and verify user-provided documents using machine learning models (e.g., genAI model 112) in this configuration.

The identity management component 118 may also update user profiles stored in user accounts 110. For example, for each type of information required in the KYC process, the identity management component 118 may store metadata that includes the last time the information was checked, an identification of the user-provided document(s) that had the information, and the methods used to verify the information.

For example, when verifying corporate structure documents such as articles of incorporation, registration certificates, and tax IDs, the identity management component 118 may record the date and time when these documents were last reviewed. It may also store information about the sources of these documents, such as whether they were uploaded directly by the user, retrieved from government registries, or obtained from third-party verification services. Additionally, the component may document the verification methods used, such as manual review by a compliance officer, automated checks using machine learning models, or cross-referencing with external databases (e.g., via validation server 108) to confirm the legitimacy of the business entity and its key individuals, such as owners, directors, or authorized signatories. Other types of documentation, such as identification documents, address verification, and income sources, may have similar metadata stored by the identity management component 118.

The trigger event detection component 116 may initiate KYC checks to ensure continuous risk assessments for users in user accounts 110. The component may be implemented in various forms, such as a webhook or a messaging platform. As a webhook, the trigger event detection component 116 may listen for specific events or changes in data and trigger the KYC process when such events occur. For example, it may be configured to detect when new documents are uploaded or when there are updates to a user's profile.

As a messaging platform, trigger event detection component 116 may receive messages or notifications from other systems or components indicating that a KYC check is required. This flexibility allows the trigger event detection component 116 to ensure that KYC checks are performed continuously and in response to relevant events, maintaining up-to-date compliance with regulatory requirements.

Other types of trigger events that the trigger event detection component 116 may handle include periodic checks, renewals, threshold-based events, external data updates, user-initiated events, compliance audits, and risk-based events. Periodic checks involve configuring trigger event detection component 116 to initiate KYC checks at regular intervals, such as daily, weekly, or monthly. User renewals may occur annually, at which time new documentation may be collected to perform a KYC process. The trigger event detection component 116 may detect this (e.g., by comparing the renewal date to a current date) and initiate the KYC process before the renewal date (e.g., a week early) to re-verify the user's identity and update their information in user accounts 110.

Threshold-based events trigger KYC checks when certain thresholds are met, such as a significant (e.g., either a nominal threshold or statistical value such as two standard deviations) change in transaction volume or frequency, which may indicate fraudulent activity. External data updates may trigger event detection component 116 listening (e.g., via webhooks, push notifications, etc.) for updates from external data sources, such as government watchlists or adverse media reports, and triggering KYC checks when relevant information about a user is updated. For example, trigger event detection component 116 may look up names in the documents and compare them to names in user accounts 110. If a match is detected, the KYC process may be initiated.

Another trigger may be if a user's name appears in appears in a news article, a court record, a social media post, a government sanction list, a politically exposed person (PEP) list, a known terrorism list, an internal watchlist list, or the like. The trigger event detection component 116 may receive a stream of document that may be parsed to look for the user's name. The parsing may use an algorithm or a fuzzy matching technique to identify a potential match, considering one or more attributes like spelling variations, aliases, and similar phonetics.

User-initiated events occur when users trigger KYC checks by updating their profile information or submitting new documents. The component detects these changes and initiates the verification process. Compliance audits are another type of trigger event where the trigger event detection component 116 may initiate KYC checks as part of routine compliance audits to ensure that all user accounts meet the regulatory standards.

Risk-based events involve initiating KYC checks based on user risk profile changes, such as new information indicating a higher risk of fraud or money laundering. A risk-based event may be triggered based on an output of risk model 114 for a user above a certain threshold (e.g., 70% risk level).

In various examples, the risk model 114 calculates an overall risk score for a user. The risk model 114 may function separately from the KYC process. For example, the risk score generated by the risk model 114 may be used in other contexts, such as credit risk assessment, transaction monitoring, or compliance audits.

Calculating a risk score for users may involve multi-dimensional analysis incorporating both static and dynamic features to produce a comprehensive risk assessment. The scoring mechanism may use supervised learning techniques such as gradient boosting or deep neural networks trained on historical user behavior patterns and known fraud cases. User-specific attributes, including demographic data (age, occupation, residential stability), financial history (credit utilization, payment patterns, account balances), and relationship metrics (tenure with institution, product diversity) may be used as inputs to the risk model 114. These static features are augmented with dynamic behavioral indicators such as transaction velocity, geographical patterns, device fingerprints, and session characteristics (time of day, IP address changes, and browser configurations).

The risk model 114 may use the output from genAI model 112 as an additional factor, converting it into a quantitative format for the risk model 114. For example, an automated textural sentiment analysis may be conducted on the output where a score of zero is correlated with a negative sentiment and one is a positive sentiment. In the case of risk model 114, the sentiment value may be used as a weighted factor in calculating the risk score for a user. In another example, the output of the genAI model 112 may be structured to include a quantitative value of the fraud risk, which may be used as an input to the risk model 114.

The risk model 114 may benefit from the continuous learning performed by the genAI model 112. As the genAI model 112 continuously improves its ability to capture insight from a broader range of inputs, it feeds a thereby evolving risk model 114. For example, when new feedback indicating that a given recommendation by (e.g., recommending enhanced due diligence) is incorrect (i.e., a false positive), the genAI model 112 may incorporate that feedback, reexamine the limitations of the algorithm that drove that false positive, and enhance its risk model to deliver better results. Similarly, as the genAI model 112 is trained on new data sets suggesting new types of fraud schemes (e.g., the creation of new false entities for international money-laundering) it develops novel algorithms to create a risk model that is better able to measure and act on risk.

Furthermore, the iterative learning of the genAI model 112 may shape the risk model 113 in such a way that it provides better recommendations for additional cycles of investigative due diligence. Such recommendations may include specific delineations of which risk assessment gaps are present in a given case, which types of due diligence must be performed, which types of databases should be researched, and so on.

Data store 122 may store data that is used by application server 102. Data store 122 is depicted as a singular element but may be multiple data stores. The data store 122 may include several databases of varying model architectures such as, but not limited to, a relational database (e.g., SQL), a non-relational database (NoSQL), a flat-file database, an object model, a document details model, graph database, shared ledger (e.g., blockchain), or a file system hierarchy. Data store 122 may store data on one or more storage devices (e.g., a hard disk, random access memory (RAM), etc.). The storage devices may be in standalone arrays, part of one or more servers, and located in one or more geographic areas.

Data structures may be implemented in several ways depending on the programming language of an application or the database management system used by an application. For example, if C++ is used, the data structure may implemented as a struct or class. In the context of a relational database, a data structure may be defined in a schema.

“Associated” in the context of linking a document to a user profile (or other data linkages described herein) may be implemented differently depending on the underlying database system. For example, in a relational database management system (RDBMS), “associated” may refer to the relationship between tables. The relationship could be one-to-one, one-to-many, or many-to-many, established through foreign key constraints. For example, in a one-to-many relationship, a record in Table A (e.g., the user profile table) may be associated with multiple records in Table B (e.g., a documents table), using a foreign key in Table B that references the primary key in Table A.

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., specially configured user interfaces). In some embodiments, computing devices may comprise one or more of a touch screen, camera, keyboard, microphone, or Global Positioning System (GPS) device. The client device 104 may use web client 106 to interact with application server 102 to perform a KYC process on a user stored in user accounts 110.

Client device 104, validation server 108, and application server 102 may communicate via a network (not shown). The network may include local-area networks (LAN), wide-area networks (WAN), wireless networks (e.g., 802.11 or cellular network), Public Switched Telephone Network (PSTN), ad hoc networks, cellular, personal area networks or peer-to-peer (e.g., Bluetooth®, Wi-Fi Direct), or other combinations or permutations of network protocols and network types. The network may include a single Local Area Network (LAN), Wide-Area Network (WAN), or combinations of LANs or WANs, such as the Internet. Client device 104, validation server 108, and application server 102 may communicate over the network.

In some examples, the communication may occur using an application programming interface (API) such as API 120. An API provides a method for computing processes to exchange data. A web-based API (e.g., API 120) may permit communications between two or more computing devices, such as a client and a server. The API may define a set of HTTP calls according to Representational State Transfer (RESTful) practices. For example, A RESTful API may define various GET, PUT, POST, and DELETE methods to create, replace, update, and delete data stored in a database (e.g., data store 122). API calls may be used to verify information received from a user. For example, an API call can be formatted with a user name and address and transmitted to validation server 108. A response package from the validation server 108 may indicate whether the name and address are valid, if they are affiliated with any known watchlists, etc.

Application server 102 may include web server 124 to enable data exchanges with client device 104 via web client 106. Although generally discussed in the context of delivering webpages via the Hypertext Transfer Protocol (HTTP), other network protocols may be utilized by web server 124 (e.g., File Transfer Protocol, Telnet, Secure Shell, etc.). A user may enter a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 124. In response, web server 124 may transmit a web page rendered on a client device's display device (e.g., a mobile phone, desktop computer, etc.).

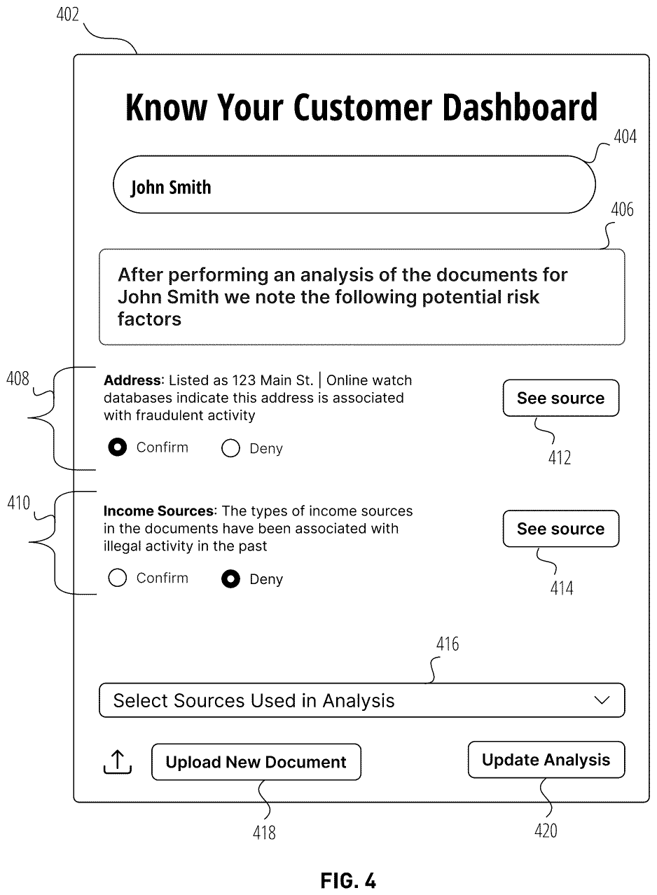

Additionally, web server 124 may enable users to interact with one or more web applications provided in a transmitted web page. A web application may provide user interface (UI) components rendered on a display device of the client device 104. The user may interact (e.g., select, move, enter text into) with the UI components, and, based on the interaction, the web application may update one or more portions of the web page. A web application may be executed in whole or in part locally on client device 104. The web application may populate the UI components with data from external or internal sources (e.g., data store 122) in various examples. In various examples, the web application is a dynamic user interface that may be used to assist with the KYC process. An example interface is described in FIG. 4.

The web application may be executed according to application logic 126. Application logic 126 may use the various elements of application server 102 to implement the web application. For example, application logic 126 may issue API calls to retrieve or store data from data store 122 and transmit it for display on client device 104. Similarly, data entered by a user into a UI component may be transmitted using API 120 back to the web server. Application logic 126 may use other elements (e.g., trigger event detection component 116, genAI model 112, risk model 114, etc.) of application server 102 to perform functionality associated with the web application as described further herein.

Application server 102 is illustrated as separate elements (e.g., components). However, the functionality of multiple individual elements may be performed by a single element. An element may represent computer program code executable by processing system 128. The program code may be stored on a storage device (e.g., data store 122) and loaded into the memory of the processing system 128 for execution. Portions of the program code may be executed in parallel across multiple processing units. A processing unit may be a grouping of one or more cores of a general-purpose computer processor, a graphical processing unit, an application-specific integrated circuit, or a tensor processing core. Furthermore, the grouping may operate on a single device or multiple devices (either collocated or geographically dispersed). Accordingly, code execution using a processing unit may be performed on a single device or distributed across multiple devices. In some examples, using shared computing infrastructure, the program code may be executed on a cloud platform (e.g., MICROSOFT AZURE® and AMAZON EC2®).

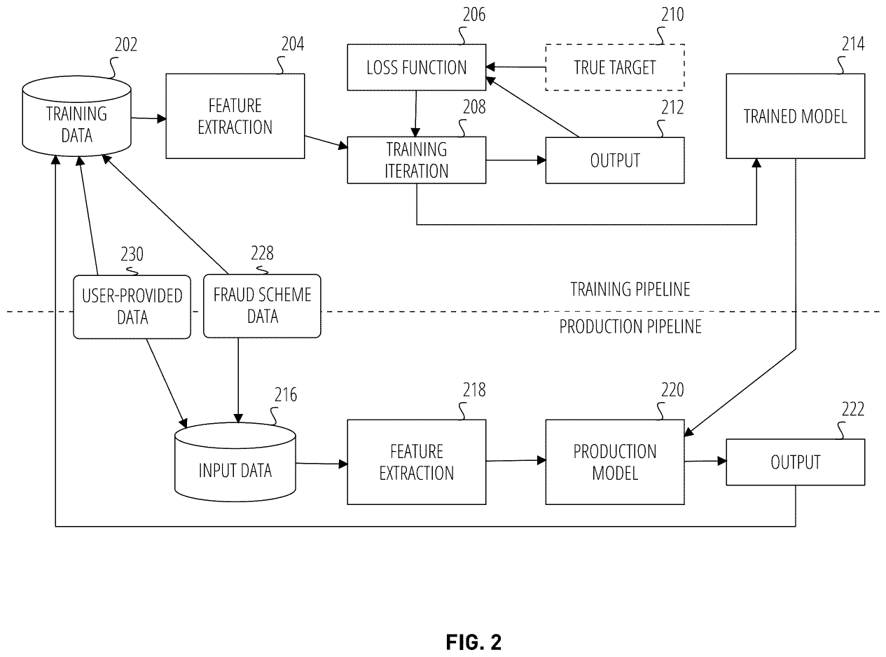

FIG. 2 is a diagram illustrating pipelines for training and using a machine learning model, according to various examples. Machine learning encompasses different algorithms used to predict or classify a data set. In general terms, there are three types of ML algorithms: supervised learning, unsupervised learning, and reinforcement learning.

Supervised learning algorithms may make a prediction based on a labeled data set (e.g., text with a rating of whether it is spam) and are generally used for classification, regression, or forecasting. Some examples of supervised learning algorithms are Naïve Bayes, Support Vector Machines, Linear Regression, Logistic Regression, Decision Trees, Random Forests, and K-Nearest Neighbor. Unsupervised learning algorithms may use an unlabeled data set (e.g., looking for clusters of similar data based on common characteristics). An example of an unsupervised learning algorithm is K-mean clustering.

Reinforcement learning algorithms generally make a prediction/decision, and then a user determines whether the prediction/decision was right-after which the machine learning model may be updated. This type of learning may be helpful when a limited input data set is available.

Neural networks (also called artificial neural networks (ANN)) are a subset of ML algorithms that may be used to solve problems similar to those of the machine learning algorithms listed above. ANNs are computational structures that are loosely modeled on biological neurons. Generally, ANNs encode information (e.g., data or decision-making) via weighted connections (e.g., synapses) between nodes (e.g., neurons). ANNs have many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others. The weights may be updated using a gradient descent technique during the training process.

Deep learning, a specialized subset of neural networks and machine learning, encompasses generative AI. Generative AI represents a further advancement in deep learning architectures, designed to create or “generate” new content by learning patterns from existing data. These systems typically employ complex neural network architectures such as transformers, variational autoencoders (VAEs), or generative adversarial networks (GANs). Unlike traditional neural networks that focus primarily on pattern recognition and classification, generative AI models are trained to understand and replicate the underlying distribution of their training data, enabling them to produce new, original content that maintains the statistical properties and characteristics of the training examples. This capability extends beyond the basic weighted connections between nodes in traditional ANNs, incorporating multiple layers of abstraction and sophisticated attention mechanisms that allow the model to capture and reproduce complex patterns in data.

Regarding FIG. 2, consider that a genAI model (e.g., genAI model 112) is being fine-tuned (e.g., trained) to assist in the KYC process. Training a machine learning model begins by collecting training data 202. The training data 202 may include user-provided data 230 and fraud scheme data 228 collected during past onboarding processes or from external data sources. The user-provided data 230 may be documents that were collected during the onboarding process. The fraud scheme data 228 may include notices from regulatory agencies explaining the latest schemes used by bad actors, a company's internal documentation of how to conduct KYC checks, governmental watchlists of people/companies that are known bad actors, etc.

The training data 202 may be based on prior completed KYC processes with known outcomes. In particular, the training data 202 may be organized in {prompt, expected answer} training pairs. The training pairs may have been manually generated to ensure their accuracy. The prompt may include a question and entire documents or excerpts of documents in user-provided data 230 or fraud scheme data 228. This prompt-answer format allows a genAI model to learn the specific task-oriented patterns and mappings required for the KYC process beyond a model's general language understanding capabilities.

A prompt is not limited to a question and may include data to answer the question. For example, a prompt may include the text of an article of incorporation document and a government watchlist with the question, “Find the principal officers from the article of incorporation. Compare the officer's names to the government watchlist. In a table form, output the names of the officers and whether the names appear in the government watchlist.” The expected answer may be a table with two columns. The first column may be the name column, and the second column may indicate whether or not a name was on the watchlist. Another training pair may include the prompt, “Given the documents available, indicate the likelihood that the account is affiliated with a legitimate business interest.” The expected answer may be a summary of the user-provided documents and any discrepancies noted. The expected answer may also identify the documents used for the summary to allow for validation by a human user.

Feature extraction 204 may include various text transformation operations to permit training. For example, feature extraction 204 may include tokenization in which the input text of a training pair is broken down into smaller units called tokens, such as words, sub-words, or characters. Another operation may be converting the tokens into numerical representations called embeddings. Embeddings capture the semantic and syntactic relationships between the tokens, allowing a model to understand the meaning and context of the input. Feature extraction 204 may also include positional encoding in which the relative position of each token in the sequence is encoded.

A training iteration 208 may include taking the prompt from a training pair and inputting it into the model being trained. The model may then output the output 212. The output 212 may be compared to the true target 210 (e.g., the expected answer from the training pair). The loss function 206 evaluates the model's performance (e.g., how well the predictions match the actual outcomes). For large language models, the loss function may be a cross-entropy function. A cross-entropy function measures the difference between the predicted probability distribution of a model and the true distribution represented by the target data (usually the next word or token in a sequence). In large language models, the loss function quantifies how well the model's predictions align with the sequence of words in the training data.

Based on this evaluation, the model's parameters (weights or biases of nodes) are updated to minimize the loss, such as using gradient descent. After a stopping condition, such as the number of epochs or convergence, the model may be considered trained (e.g., trained model 214).

Turning to the production pipeline of FIG. 2, the trained model 214 is used as the production model 220. Input data 216 may include updated data for use in performing KYC continuously for users. The feature extraction 218 operations may be performed on the prompt submitted by a user or automated process similar to the feature extraction 204 operations. After feature extraction 218, the prompt may be submitted to production model 220, in which output 222 is generated.

The production model 220 may be updated based on user validations. For example, after reviewing output 222, a user may mark the output as correct or incorrect. If the output is incorrect, the user may enter the correct answer. Over time, the user validation data may be collected and used as further training data to increase the accuracy of the production model 220.

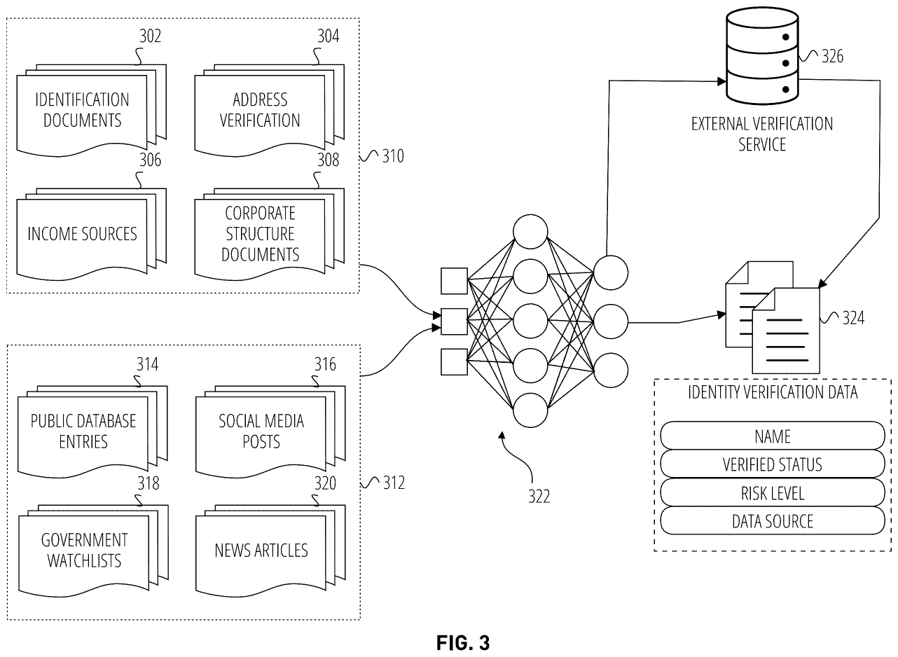

FIG. 3 is a block diagram illustrating using a genAI model to generate identity verification data, according to various examples. The genAI model 322 may be trained using training pairs described in FIG. 2. The genAI model 322 may be executed in response to a trigger event (e.g., as detected by trigger event detection component 116 in FIG. 1).

One or more of the user-provided data 310 and external data sources 312 may be used with a prompt to genAI model 322. User-provided data 310 may include identification documents 302, address verification document 304, income sources 306, and corporate structure documents 308 that were either previously provided by a user or updated documentation provided by a user. External data sources 312 may include information collected automatically (e.g., via an API) and include public database entries 314, social media posts 316, government watchlists 318, and news articles 320. Other types of data sources may include bulletins describing the latest fraud techniques, and subscription-based databases and services providing firmographic data, data associated with company structure, ownership, financial position, and fraud notifications.

The documents selected for use with a prompt may be considered adding the documents to a context window. Adding a document to a context window for large language models (LLMs) means providing the model with additional text input, which the model may use to generate responses based on the information within that document. The “context window” refers to the maximum amount of text or tokens (pieces of words) the model may consider at one time. When a document is added to this window, the relevant information is loaded into the model's immediate memory, allowing it to refer to specific details, facts, or instructions within that document while answering questions or performing tasks.

A model may only use what is within the context window. Thus, if the sum of a document's tokens is too long, only part of the document may fit. To address this problem, retrieval-augmented generation (RAG) is a method that allows LLMs to handle extensive documents by incorporating a retrieval mechanism to identify and provide the most relevant portions of a document for the model's context window. In RAG, a document is split into smaller chunks that are then indexed using vector embeddings. A vector embedding is a numerical representation of text based on its meaning. When a user enters a prompt, RAG finds the most relevant chunks by matching (e.g., using cosine similarity) the query to these indexed portions. These sections are then added to the LLM's context window.

Another method to reduce the number of documents (e.g., to fit into the context window) is to select documents previously indicated to have information for the KYC process. For example, a user account may include the identifier of documents that contain names and other verification information used in prior KYC checks.

The output from genAI model 322 may be identity verification data 324. The identity verification data 324 may include names, their verified status, a risk level, and the data source for the original and validated information. The output format may be a function of the prompt used for genAI model 322.

The identity verification data 324 may be augmented by automatic calls to external verification service 326 using the genAI model 322 information output. The external verification service 326 may be an API-based service configured to validate information or compare it to up-to-date watchlists. For example, the external verification service 326 may take a name and address (e.g., identity information) and respond in a JavaScript Object Notation format with a payload indicating the veracity (e.g., are they real and match) of the name and address.

A user or automated process may review the identity verification data 324 to determine whether an account mitigation technique should be implemented. The automated process may be another machine learning model, such as risk model 114 of FIG. 1.

FIG. 4 is a user interface for reviewing the output of a genAI model, according to various examples. The user interface 402 is a visual interface through which users may interact with the system to review and validate the output generated by a genAI model (e.g., genAI model 112). The user interface 402 may be presented on a client device 104 and include various elements facilitating the review process.

The search element 404 allows users to input the name of a person or business that is having a KYC process performed. For example, search element 404 has the name John Smith. The search element 404 may be implemented as a text input field with an associated search button (not shown), enabling users to perform a genAI-based KYC check.

The layout and formatting of summary output 406, data point 408, and data point 410 are only one example, and others may be used. Furthermore, the output layout may correlate with the prompt and training pairs used for the genAI model. In the example of user interface 402, the genAI model may have been trained to include a summary output (e.g., summary output 406) and then list individual elements (e.g., data point 408 and data point 410).

Data point 408 and data point 410 410 represent individual pieces of information extracted or analyzed by the genAI model. Although user interface 402 shows only two, there may be more or fewer. These data points may include details such as names, addresses, identification numbers, and other relevant attributes. Each data point may be displayed with the corresponding verification status and source information, providing users with a clear understanding of the data's authenticity and reliability. Source links 412 and 414 provide direct access to the original documents or data sources from which the information was extracted. These links enable users to verify the accuracy of the data by reviewing the original documents. Source links 412 and 414 may be implemented as clickable hyperlinks that open the associated documents in a new browser tab or window, facilitating easy access to the source material.

In various examples, the document selection element 416 allows users to select specific documents for inclusion in a context window of a genAI model. This element may be implemented as a dropdown menu, checkbox list, or other selection mechanism, enabling users to choose one or more documents from a list of available options. The upload element 418 enables users to upload new documents or updated versions of existing documents to the system. This element may be implemented as a file input field, allowing users to browse their local file system and select the desired files for upload.

The analysis initiation element 420 allows users to initiate the analysis process using the genAI model. This element may be implemented as a button or other interactive component that, when clicked, triggers the genAI model to process the selected documents and generate the identity verification data. The analysis initiation element 420 allows users to control when the analysis is performed instead of relying on an automatic trigger event.

The user interface 402 also includes confirm/deny radio buttons associated with each data point, such as data point 410. These radio buttons allow users to provide feedback on the accuracy of the genAI model's output. If a user marks “confirm” on a data point, it indicates that the genAI model's output is correct and the information is accurate. Conversely, if a user marks “deny” on a data point, it indicates that the genAI model's output is incorrect and no fraud was found.

When a user marks “deny” on a data point, such as data point 410, this feedback is used to update the genAI model. The system captures the denied data point and the associated input data as a new training pair. This new training pair includes the original prompt and the correct answer provided by the user. By incorporating feedback from multiple users over time into the training data, the genAI model can learn from its mistakes and improve its accuracy over time.

Although not shown in FIG. 4, a suggested mitigation action to be taken on the user account may be displayed (e.g., in response to a risk score being above a certain threshold).

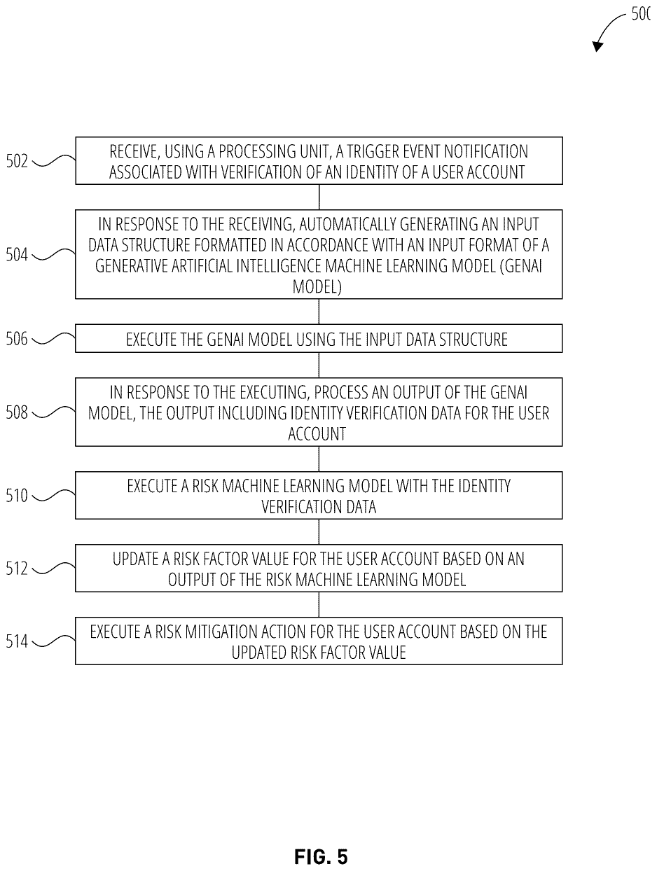

FIG. 5 is a flowchart illustrating a method to execute a generative artificial intelligence model to verify data, according to various examples. The method is represented as a set of blocks 502 to 514 that describe operations. The method may be embodied in a set of instructions stored in at least one computer-readable storage device of a computing device. A computer-readable storage device excludes transitory signals. In contrast, a signal-bearing medium may include such transitory signals. A machine-readable medium may be a computer-readable storage device or a signal-bearing medium. A processing unit, which executing the set of instructions, may configure the processing unit to perform the operations illustrated in FIG. 5. The processing unit may instruct other component of a computing device to carry out the set of instructions. For example, the processing unit may instruct a network device to transmit data to another computing device or the computing device may provide data over a display interface to present a user interface. In some examples, performance of the method may be split across multiple computing devices using a shared computing infrastructure (e.g., the processing unit encompasses multiple distributed computing devices).

In block 502, method 500 includes receiving, using a processing unit, a trigger event notification associated with the verification of the identity of a user account. The trigger event may be a periodic trigger event notification. For example, the trigger event detection component 116 of FIG. 1 may detect the event and initiate the KYC process. The trigger event detection component 116 from FIG. 1 may be configured to detect various types of events that necessitate identity verification, such as new documentation submissions, periodic reviews, or updates to user profiles.

In block 504, method 500 includes in response to the receiving, automatically generating an input data structure formatted in accordance with an input format of a generative artificial intelligence machine learning model (genAI model). For example, the input data structure may be generated by the identity management component 118 of FIG. 1 which formats the data to be compatible with the genAI model 112. Examples of input data structures may include tokenized text from user-provided documents, numerical embeddings representing the semantic and syntactic relationships of the text, and positional encodings to capture the order and context within sequences as described in the feature extraction operations of FIG. 2.

The operation of block 504 may further include selecting, using the processing unit, an input prompt and adding a data file to a context window of the genAI model. In various examples, receiving the indication of a trigger event associated with the verification of the identity of the user account includes receiving the data file. For example, the data file may be a document such as an identification document 302 or an address verification document 304 as shown in FIG. 3.

In various examples, adding a data file to a context window of the genAI model includes accessing a data store of data files previously used for identity verification data for the user account. For example, the data store 122 of FIG. 1 may be accessed to retrieve documents that were previously verified and stored.

In various examples, adding a data file to a context window of the genAI model includes accessing the data file using retrieval-augmented generation (RAG). RAG may be used to identify and provide the most relevant portions of a document for the model's context window, as described in FIG. 3. This method ensures that the most pertinent information is used and optimizes the model's performance.

In block 506, method 500 includes executing the genAI model using the input data structure. For example, the genAI model 112 of FIG. 1 may be executed using the formatted input data structure to generate identity verification data.

In block 508, method 500 includes in response to the executing, processing an output of the genAI model, the output including identity verification data for the user account. For example, the identity verification data 324 generated by the genAI model 322 in FIG. 3 may be processed to include verified names, risk levels, and data sources.

In various examples, the method 500 may include presenting the output on a user interface, the output including an identification of a source of the identity verification data and receiving confirmation of the identity verification data via the user interface. For example, the user interface 402 of FIG. 4 may display the identity verification data along with source links 412 and 414, allowing users to confirm the accuracy of the data.

In block 510, method 500 includes executing a risk machine learning model with the identity verification data. For example, the risk model 114 of FIG. 1 may use the identity verification data to assess the risk associated with the user account.

In various examples, the method 500 may further include formatting an application programming interface call to an external service with an identity parameter based on the identity verification data output from the genAI model. The API call may be transmitted to the external service a response data payload may be received. The data payload may be input to the risk machine learning model.

For example, the API 120 of FIG. 1 may be used to send the identity verification data to an external verification service 326 as shown in FIG. 3. The response data payload from the external service may then be used to further refine the risk assessment.

In block 512, method 500 includes updating a risk factor value for the user account based on an output of the risk machine learning model.

For example, the risk model 114 of FIG. 1 may generate an updated risk score based on the identity verification data processed by the genAI model 112. The identity verification data output from the genAI model may be converted into a format that is usable by the risk model 114 by structuring the data into a standardized format such as JSON or CSV. This conversion process may involve extracting key attributes such as names, addresses, and risk levels from the identity verification data and organizing them into a structured format. The structured data may then be input into the risk model 114 which can process the data to generate a quantitative risk assessment (e.g., using a weighted algorithm or neural network).

In block 514, method 500 includes executing a risk mitigation action for the user account based on the updated risk factor value. For example, if the updated risk score exceeds a certain threshold, the identity management component 118 of FIG. 1 may automatically implement a risk mitigation action such as freezing the user account or flagging it for further review. Other risk mitigation actions may be an investigation of the user's background, a more thorough investigation of the user's account, sending a report of the suspicious activity to the relevant personnel, a spending or use restriction on a user's account, or informing authorities for a potential criminal investigation.

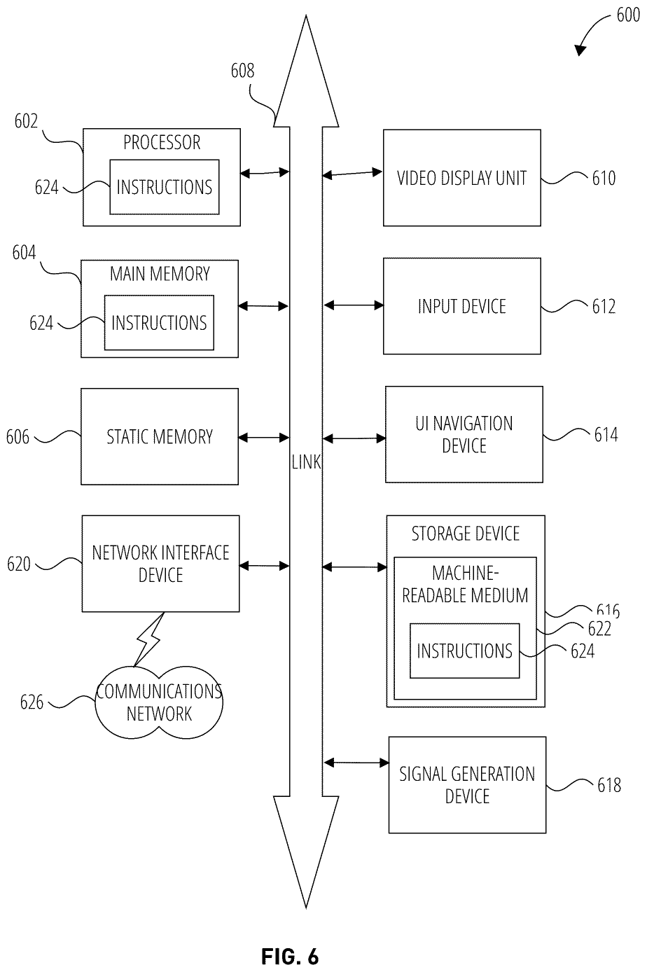

FIG. 6 is a block diagram illustrating a machine in the example form of computer system 600, within which a set or sequence of instructions may be executed to cause the machine to perform any of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) Network environments. The machine may be an onboard vehicle system, wearable device, personal computer (PC), tablet PC, hybrid tablet, personal digital assistant (PDA), mobile telephone, or any machine capable of executing instructions (sequential or otherwise) that specify actions to be taken by that machine. Further, while only a single machine is illustrated, the term “machine” includes any collection of machines that individually or jointly execute a set (or multiple sets) of instructions to perform any of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein Example computer system 600 includes at least one processor 602 (e.g., a central processing unit (CPU), a graphics processing unit (GPU) or both, processor cores, compute nodes, etc.), a main memory 604, and a static memory 606, which communicate with each other via a link 608. The computer system 600 may include a video display unit 610, an input device 612 (e.g., a keyboard), and a user interface UI navigation device 614 (e.g., a mouse). In an example, the video display unit 610, input device 612, and UI navigation device 614 are incorporated into a single device housing, such as a touchscreen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensors.

The storage device 616 includes a machine-readable medium 622 on which one or more sets of data structures and instructions 624 (e.g., software) embodying or utilized by any of the methodologies or functions described herein. The instructions 624 may also reside, completely or at least partially, within the main memory 604, the static memory 606, or within the processor 602 during execution thereof by the computer system 600, with the main memory 604, the static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database or associated caches and servers) that store the instructions 624. The term “machine-readable medium” shall also be taken to include any tangible medium that is capable of storing, encoding, or carrying instructions for execution by the machine and that causes the machine to perform any one or more of the methodologies of the present disclosure or that is capable of storing, encoding or carrying data structures utilized by or associated with such instructions. The term “machine-readable medium” includes, but is not limited to, solid-state memories and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. A computer-readable storage device may be a machine-readable medium 622 that excludes transitory signals.

The instructions 624 may be transmitted or received over a communications network 626 using a transmission medium via the network interface device 620 utilizing a transfer protocol (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine and includes digital or analog communications signals or other intangible mediums to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
receiving, using a processing unit, a trigger event notification associated with verification of an identity of a user account;
in response to the receiving, automatically generating an input data structure formatted in accordance with an input format of a generative artificial intelligence machine learning model (genAI model);
executing the genAI model using the input data structure, wherein the genAI model is trained using training data organized as prompt and expected answer training pairs based on prior completed identity verification processes with known outcomes;
in response to the executing, processing an output of the genAI model, the output including identity verification data for the user account;
executing a risk machine learning model with the identity verification data;
updating a risk factor value for the user account based on an output of the risk machine learning model; and
executing a risk mitigation action for the user account based on the updated risk factor value.

2. The method of claim 1, wherein automatically generating the input data structure formatted in accordance with the input format of the genAI model includes:
selecting, using the processing unit, an input prompt; and
adding a data file to a context window of the genAI model.

3. The method of claim 2, wherein receiving the trigger event notification associated with verification of identity of the user account includes receiving the data file.

4. The method of claim 2, wherein adding a data file to a context window of the genAI model includes:
accessing a data store of data files previously used for identity verification data for the user account.

5. The method of claim 2, wherein adding a data file to a context window of the genAI model includes:
accessing the data file using retrieval-augmented generation.

6. The method of claim 1, further comprising:
presenting the output on a user interface, the output including an identification of a source of the identity verification data; and
receiving confirmation of the identity verification data via the user interface.

7. The method of claim 1, further comprising:
formatting an application programming interface call to a external service, the call including an identity parameter based on the identity verification data output from the genAI model;
transmitting the application programming interface call to the external service;
receiving a response data payload from the external service; and
inputting the data payload to the risk machine learning model.

8. The method of claim 1, wherein the trigger event notification is a periodic trigger event notification.

9. A non-transitory computer-readable medium comprising instructions, which when executed by a processing unit, configure the processing unit to perform operations comprising:
receiving a trigger event notification associated with verification of an identity of a user account;
in response to the receiving, automatically generating an input data structure formatted in accordance with an input format of a generative artificial intelligence machine learning model (genAI model);
executing the genAI model using the input data structure, wherein the genAI model is trained using training data organized as prompt and expected answer training pairs based on prior completed identity verification processes with known outcomes;
in response to the executing, processing an output of the genAI model, the output including identity verification data for the user account;
executing a risk machine learning model with the identity verification data;
updating a risk factor value for the user account based on an output of the risk machine learning model; and
executing a risk mitigation action for the user account based on the updated risk factor value.

10. The non-transitory computer-readable medium of claim 9, wherein automatically generating the input data structure formatted in accordance with the input format of the genAI model includes:
selecting an input prompt; and
adding a data file to a context window of the genAI model.

11. The non-transitory computer-readable medium of claim 10, wherein receiving the trigger event notification associated with verification of identity of the user account includes receiving the data file.

12. The non-transitory computer-readable medium of claim 10, wherein adding a data file to a context window of the genAI model includes:
accessing a data store of data files previously used for identity verification data for the user account.

13. The non-transitory computer-readable medium of claim 10, wherein adding a data file to a context window of the genAI model includes:
accessing the data file using retrieval-augmented generation.

14. The non-transitory computer-readable medium of claim 9, wherein the instructions, which when executed by the processing unit, further configure the processing unit to perform operations comprising:
presenting the output on a user interface, the output including an identification of a source of the identity verification data, and
receiving confirmation of the identity verification data via the user interface.

15. The non-transitory computer-readable medium of claim 9, wherein the instructions, which when executed by the processing unit, further configure the processing unit to perform operations comprising:
formatting an application programming interface call to a external service, the call including an identity parameter based on the identity verification data output from the genAI model;
transmitting the application programming interface call to the external service;
receiving a response data payload from the external service; and
inputting the data payload to the risk machine learning model.

16. The non-transitory computer-readable medium of claim 9, wherein the trigger event notification is a periodic trigger event notification.

17. A system comprising:
a processing unit; and
a storage device comprising instructions, which when executed by the processing unit, configure the processing unit to perform operations comprising:
receiving trigger event notification associated with verification of an identity of a user account,
in response to the receiving, automatically generating an input data structure formatted in accordance with an input format of a generative artificial intelligence machine learning model (genAI model);
executing the genAI model using the input data structure, wherein the genAI model is trained using training data organized as prompt and expected answer training pairs based on prior completed identity verification processes with known outcomes;
in response to the executing, processing an output of the genAI model, the output including identity verification data for the user account;
executing a risk machine learning model with the identity verification data;
updating a risk factor value for the user account based on an output of the risk machine learning model; and
executing a risk mitigation action for the user account based on the updated risk factor value.

18. The system of claim 17, wherein automatically generating the input data structure formatted in accordance with the input format of the genAI model includes:
selecting an input prompt; and
adding a data file to a context window of the genAI model.

19. The system of claim 18, wherein receiving the trigger event notification associated with verification of identity of the user account includes receiving the data file.

20. The system of claim 18, wherein adding a data file to a context window of the genAI model includes:
accessing a data store of data files previously used for identity verification data for the user account.
